(19) United States
(12) Patent Application Publication
(10) Pub. No.: US 2012/0230905 A1
(43) Pub. Date: Sep. 13, 2012

(54) PROCESS FOR PYROLYSIS OF CARBOHYDRATES

(75) Inventors: Alfons Karl, Grundau (DE); Jürgen Erwin Lang, Karlsruhe (DE); Hartwig Rauleder, Rheinfelden (DE); Bodo Frings, Schloss Holte (DE)

(73) Assignee: EVONIK DEGUSSA GMBH, Essen (DE)

(21) Appl. No.: 13/509,839

(22) PCT Filed: Nov. 4, 2010
(86) PCT No.: PCT/EP2010/066800

§ 371 Date: May 15, 2012

(30) Foreign Application Priority Data
Nov. 16, 2009 (EP) 09176045.4

(51) Int. Cl. C01B 33/025; C09K 3/00

(52) U.S. Cl. 423/350; 252/183.14

(57) ABSTRACT

The present invention relates to processes for industrial pyrolysis of a carbohydrate or carbohydrate mixture with addition of amorphous carbon, to a pyrolysis product thus obtainable and to the use thereof, especially as a reducing agent in the production of silicon from silica and carbon at high temperature.

The present invention relates to an industrial process for pyrolysis of carbohydrates, especially of sugar, to the pyrolysis product thus obtainable and to the use thereof, preferably in the production of silicon, more preferably solar silicon, from silica and carbon at high temperature.

It is known that carbohydrates, for example mono-, oligo- and polysaccharides, can be pyrolysed in gas chromatographs.

U.S. Pat. No. 5,882,726 discloses a process for preparing a carbon-carbon composition, wherein a pyrolysis of a low-melting sugar is performed.

GB 733 376 discloses a process for purifying a sugar solution, and for pyrolysis at 300 to 400° C.

It is likewise known that sugar can be pyrolysed at high temperature in order to obtain an electron-conductive substance (WO 2005/051840).

In the industrial scale pyrolysis of carbohydrates, there may be problems as a result of caramelization and foam formation, which can considerably disrupt the management and the running of the process. DE 10 2008 042 498 proposes solving this problem by adding a silica to the carbohydrate before the pyrolysis, said silica acting as a defoamer and being intended to reduce caramelization. A disadvantage of this process is that a pyrolysis product contaminated with the silica is obtained and, according to the use of the pyrolysis product, has to be purified again.

It is also known that sugars and other substances can be used as reducing agents with a small proportion of impurities (U.S. Pat. No. 4,294,811, WO 2007/106860) or as binders (U.S. Pat. No. 4,247,528) in the production of pure silicon.

It was an object of the present invention to provide an improved process for pyrolysis of carbohydrates, especially of sugar, in which foam formation is reduced or is ideally avoided, and which has the disadvantages of the prior art processes only to a reduced degree, if at all.

It was a specific object of the present invention to provide an equivalent to wood chips in silicon production, which meets the purity and stability requirements in solar silicon production but still fulfils the function of the wood chips, namely that of preventing conglutination of the charge.

Further objects which are not stated explicitly are evident from the overall context of the description, examples and claims which follow.

The objects are achieved in accordance with the invention according to the details in the description, the examples and the claims.

Thus, it has been found that, surprisingly, addition of amorphous carbon to the carbohydrate to be pyrolysed can reduce or entirely suppress the foam formation effect. In this way, a pyrolysis product is obtained which consists virtually completely of carbon and thus has a very low ash content. This is a great advantage compared to pyrolysates which are produced with silicas as defoamers. The inventive pyrolysates can thus be used to produce high-purity products.

The process according to the invention can now be used to operate industrial processes for pyrolysis of carbohydrates in a simple and economically viable manner without troublesome foam formation and without troublesome silica impurities in the end product.

Furthermore, it has been found in the performance of the process according to the invention that caramelization can be reduced or suppressed.

In a specific embodiment, that of in situ pyrolysis in metallurgical processes, the process according to the invention additionally has the advantage that the gases formed lead to bulking of the melt, i.e. can prevent conglutination.

The process according to the invention allows performance of the pyrolysis at very low temperatures. Thus, it is advantageous, since it is particularly energy-saving (low-temperature mode), to lower the pyrolysis temperature in the process according to the invention from 1600° C. to 1700° C. down to below 800° C. Thus, the process according to the invention, in a first embodiment, is operated preferably at a temperature of 250° C. to 800° C., more preferably at 300 to 800° C., even more preferably at 350 to 700° C. and especially preferably at 400 to 600° C. This process is extremely energy-efficient and additionally has the advantage that caramelization is reduced and the handling of the gaseous reaction products is facilitated.

However, it is also possible in principle, in a second preferred embodiment, to perform the reaction between 800 and 1700° C., more preferably between 900 and 1600° C., even more preferably at 1000 to 1500° C. and especially at 1000 to 1400° C. In general, this gives a graphite-containing pyrolysis product which has advantageous properties for particular applications. If a graphite-containing pyrolysis product is preferred, a pyrolysis temperature of 1300 to 1500° C. should be pursued.

The process according to the invention is advantageously performed under protective gas and/or under reduced pressure (vacuum). Thus, the process according to the invention is advantageously performed at a pressure of 1 mbar to 1 bar (ambient pressure), especially of 1 to 10 mbar. Appropriately, the pyrolysis apparatus used is dried before the start of pyrolysis and is purged to virtually free it of oxygen by purging with an inert gas, such as nitrogen or argon or helium. The pyrolysis time in the process according to the invention is generally between 1 minute and 48 hours, preferably between ¼ hour and 18 hours, especially between ½ hour and 12 hours, at said pyrolysis temperature, in which case the heating time until attainment of the desired pyrolysis temperature may additionally be within the same order of magnitude, especially between ¼ hour and 8 hours. The present process is generally performed batchwise; however, it can also be performed continuously.

Since carbohydrates generally have a very high purity and even amorphous carbons are available with a high purity, it is possible with the process according to the invention to obtain a C-based pyrolysis product which comprises charcoal, especially with graphite contents and optionally contents of other carbon forms, such as Coke. It is especially possible to obtain a product which is particularly low in impurities, for example compounds of B, P, As and Al. Such an inventive pyrolysis product can be used advantageously as a reducing agent in the production of silicon, especially metallurgical silicon, and even solar silicon, from silica at high temperature. More particularly, the inventive graphite-containing pyrolysis product, owing to its conductivity properties, can be used in a light arc reactor.

In principle, the pyrolysis product can, however, also be used in all other fields of use in which pure carbon is required, for example in metal carbide production (boron carbide, silicon carbide, etc.) or the production of graphite mouldings, preferably electrodes, especially high-purity electrodes, carbon brushes, heating elements, heat exchangers, or as a carburizing agent for steel or in diamond production or as a reducing agent in hard metal production (W, Mo, Cr, Ti, Ta, Co, V, etc.) or in zirconium production or as a blanket for metal melts or as a substitute for wood chips in metallurgical processes.

The present invention therefore provides a process for industrial pyrolysis of a carbohydrate or carbohydrate mixture with addition of amorphous carbon.

The carbohydrate or component of the carbohydrate mixture which is used in the process according to the invention preferably include monosaccharides, i.e. aldoses or ketoses, such as trioses, tetroses, pentoses, hexoses, heptoses, particularly glucose and fructose, but also corresponding oligo- and polysaccharides based on said monomers, such as lactose, maltose, sucrose, raffinose,—to name just a few, or derivatives thereof—up to and including starch, including amylose and amylopectin, the glycogens, the glycosans and fructosans—to name just a few polysaccharides.

If a particularly pure pyrolysis product is required, the process according to the invention is preferably modified to the effect that the aforementioned carbohydrates are additionally purified by a treatment using an ion exchanger, in which case the carbohydrate is dissolved in a suitable solvent, advantageously water, more preferably deionized or demineralized water, and conducted through a column filled with an ion exchange resin, preferably an anionic or cationic resin, the resulting solution is concentrated, for example by removing solvent components by heating—especially under reduced pressure—and the carbohydrate thus purified is advantageously obtained in crystalline form, for example by cooling the solution and then removing the crystalline components, by means of methods including filtration or centrifuging. The person skilled in the art is aware of various ion exchangers for removing different ions. It is possible in principle to connect a sufficient number of ion exchanger steps in series to achieve the desired purity of the sugar solution. Alternatively to purification by means of ion exchangers, it is, however, also possible to take other measures known to those skilled in the art to purify the carbohydrate reactants. Examples here include: addition of complexing agents, electrochemical purification methods, chromatographic methods.

In the process according to the invention, it is also possible to use a mixture of at least two of the aforementioned carbohydrates as the carbohydrate or carbohydrate component. Particular preference is given in the process according to the invention to a crystalline sugar available in economically viable amounts, a sugar as can be obtained in a manner known per se, for example, by crystallization of a solution or a juice from sugarcane or beets, i.e. commercially available crystalline sugar, for example refined sugar, preferably a crystalline sugar with the substance-specific melting point/softening range and a mean particle size of 1 μm to 10 cm, more preferably of 10 μm to 1 cm, especially of 100 μm to 0.5 cm. The particle size can be determined, for example—but not exclusively—by means of screen analysis, TEM, SEM or light microscopy. However, it is also possible to use a carbohydrate in dissolved form, for example—but not exclusively—in aqueous solution, in which case the solvent admittedly evaporates more or less rapidly before attainment of the actual pyrolysis temperature.

The amorphous carbon used is preferably activated carbon or a carbon black or a pyrolysed carbohydrate, especially pyrolysed sugar, or mixtures thereof.

Particular preference is given to using carbon blacks which have been produced by the furnace black process, the gas black process, the lamp black process, the acetylene black process or the thermal black process. These processes for producing carbon black are sufficiently well known to the person skilled in the art. One example of a known process for producing carbon blacks is the gas black process (German Reich Patent 29261, DE-C 2931907, DE-C 671739, Carbon Black, Prof. Donnet, 1993 by MARCEL DEKKER, INC, New York, page 57 ff.), in which a hydrogen-containing carrier gas laden with oil vapours is combusted in an air excess at numerous exit orifices. The flames hit water-cooled rollers, which stops the combustion reaction. Some of the carbon black formed in the flame interior is precipitated on the rollers and is scraped off them. The carbon black remaining in the offgas stream is removed in filters. Also known is the channel black process (Carbon Black, Prof. Donnet, 1993 by MARCEL DEKKER, INC, New York, page 57 ff.), in which a multitude of small flames fed by natural gas burn against water-cooled iron channels. The carbon black deposited on the iron channels is scraped off and collected in a funnel. Customary reactors for production of carbon black are operated at process temperatures of 1200° C. to more than 2200° C. in the combustion chamber. The process according to the invention encompasses, in a general manner, all carbon black production processes and furnaces which are suitable for carbon black production. These may in turn be equipped with different burner technologies. One example thereof is the Hüls light arc furnace (light arc). A crucial factor for the selection of the burner is whether a high temperature in the flame or a rich flame is to be obtained. The reactors may comprise the following burner units: gas burners with an integrated combustion air blower, gas burners for swirled air streams, combination gas burners with gas injection via peripheral probes, high-velocity burners, Schoppe impulse burners, parallel diffusion burners, combined oil-gas burners, pusher furnace burners, oil evaporation burners, burners with air or vapour atomization, flat flame burners, gas-fired jacketed jet pipes, and all burners and reactors which are suitable for production of carbon black or for pyrolysis of carbohydrates.

In the process according to the invention, preference is given to using a lamp black or a gas black or a furnace black. Very particular preference is given to using gas blacks. Very particular preference is likewise given to using furnace blacks or oxidized furnace blacks, especially with low structure, i.e. a DBP of less than or equal to 75 ml/(100 g).

The amorphous carbon used in the process according to the invention preferably has an internal surface area of 1 to 1000 m²/g, more preferably of 5 to 800 m²/g, especially of 10 to 700 m²/g. The internal or specific surface area is determined by the BET method (ASTM D 6556).

Also preferably, the amorphous carbon used in the process according to the invention has an STSA surface area of 1 to 600 m²/g, more preferably of 5 to 500 m²/g, especially of 10 to 450 m²/g. The STSA surface area is determined to ASTM D 6556.

Likewise preferably, the amorphous carbon used in the process according to the invention has a DBP absorption of 10 to 300 ml/(100 g), more preferably of 20 to 250 ml/(100 g), especially of 30 to 200 ml/(100 g). The DBP absorption is determined to ASTM D 2414. Especially in the case of furnace blacks or oxidized furnace blacks, it has been found to be particularly advantageous when they have a relatively low structure, i.e. a DBP absorption of less than 75 ml/(100 g), preferably 10 to 75 ml/(100 g), more preferably 20 to 60 ml/(100 g).

In addition, it has been found that the pH of the amorphous carbon component used in accordance with the invention, measured to ASTM D 1512, should preferably be less than or equal to 11, more preferably 1 to 10.

In a specific embodiment, the amorphous carbon component used in accordance with the invention has a combination of the aforementioned physicochemical properties.

When the purity of the end products in the process according to the invention is particularly important, the reactants more preferably have the profile of impurities defined below. The mixing ratio of carbohydrate to defoamer, i.e. amorphous carbon, calculated as parts by weight of carbon, in the process according to the invention is preferably within a range from 1000:0.1 to 0.1:1000. More particularly, the weight ratio of carbohydrate components to amorphous carbon components can, however, be adjusted to 800:0.1 to 1:1, more preferably to 500:1 to 20:1, even more preferably to 250:1 to 10:1 and especially preferably to 200:1 to 5:1.

The carbohydrate component and the component composed of amorphous carbon can be mixed, preferably in pulverulent form, and the mixture can be pyrolysed. However, it is also possible to subject the mixture to a shaping process before the pyrolysis. For this purpose, all shaping processes known to those skilled in the art can be employed. Suitable processes, for example briquetting, extrusion, pressing, tabletting, pelletizing, granulating, and further processes known per se, are sufficiently well known to those skilled in the art. In order to obtain stable shaped bodies, it is possible to add, for example, carbohydrate solution or molasses or lignosulfonate or “pentalauge” (waste liquor from pentaerythritol production) or polymer dispersions, for example polyvinyl alcohol, polyethylene oxide, polyacrylate, polyurethane, polyvinyl acetate, styrene-butadiene, styrene-acrylate, natural latex, or mixtures thereof as binders.

The apparatus used for the performance of the process according to the invention can, for example, be an induction-heated vacuum reactor, in which case the reactor may be made of stainless steel. When particularly pure pyrolysis products are required, the reactor may preferably be coated or lined with a suitable substance which is inert with respect to the reaction. For example, it is possible to use high-purity SiC, Si₃N₃, high-purity quartz glass or silica glass, high-purity carbon or graphite, ceramic. However, it is also possible to use other suitable reaction vessels, for example an induction oven with a vacuum chamber for accommodation of appropriate reaction crucibles or vats.

The process according to the invention is preferably performed as follows:

The reactor interior and the reaction vessel are suitably dried and purged with an inert gas, which may be heated, for example, to a temperature between room temperature and 300° C. Subsequently, the mixture to be pyrolysed or the shaped body made from carbohydrate or carbohydrate mixture, as well as the amorphous carbon as a defoamer component, is charged into the reaction chamber or the reaction vessel of the pyrolysis apparatus. In the case of mixtures, the feedstocks are preferably mixed intimately beforehand, degassed under reduced pressure and transferred into the prepared reactor under protective gas. In this case, the reactor may already be slightly preheated. Subsequently, the temperature can be adjusted continuously or stepwise to the desired pyrolysis temperature and the pressure can be reduced in order to be able to remove the gaseous decomposition products which escape from the reaction mixture as rapidly as possible. Especially as a result of the addition of amorphous carbon, it is advantageous to very substantially prevent foam formation of the reaction mixture. After the pyrolysis reaction has ended, the pyrolysis product can be thermally aftertreated for a while, advantageously at a temperature in the range from 1000 to 1500° C.

In general, this gives a pyrolysis product or a composition which contains virtually exclusively carbon. In a preferred embodiment, this pyrolysis product is notable especially for a very low ash content of less than 0.5% by weight, more preferably 0.0000001 to 0.1% by weight, even more preferably 0.000001 to 0.01% by weight and especially preferably 0.000001 to 0.001% by weight. The ash content is determined to ASTM D-1506-92. More particularly, the direct process product of the pyrolysis process according to the invention, when high-purity reactants are used, is notable for its high purity and usability for the production of polycrystalline silicon, especially of solar silicon for photovoltaic systems, but also for medical applications. What should be understood by high-purity reactants and pyrolysis products is defined below.

As stated, an inventive composition (also referred to a pyrolysate or pyrolysis product for short) can be used particularly advantageously as a feedstock in the production of solar silicon by reduction of SiO₂ at elevated temperature, especially in a light arc furnace. For instance, the inventive direct process product can be used in a simple and economically viable manner as a C-containing reducing agent in a process as disclosed, for example, in U.S. Pat. No. 4,247,528, U.S. Pat. No. 4,460,556, U.S. Pat. No. 4,294,811 and WO 2007/106860.

In a specific embodiment, the process according to the invention, however, can also be combined with the carbothermic reduction of silica, in such a way that inventive shaped bodies formed from unpyrolysed carbohydrate or carbohydrate mixture and the amorphous carbon component are introduced directly into the reduction furnace, especially preferably in the abovementioned weight ratios, such that in situ pyrolysis of the carbohydrate therein generates the carbon component required for the carbothermic reduction of the silica.

In other words, if the inventive pyrolysis product is to be used for production of silicon, it is possible either first to perform the inventive pyrolysis and to supply the finished pyrolysed product to the carbothermic reduction, or, as described above, to introduce a shaped body formed from unpyrolysed carbohydrate or carbohydrate mixture and the amorphous carbon component into the reduction reactor in such a way that the carbon reducing agent required is formed in situ by the inventive pyrolysis reaction. The present invention thus provides both for the use of the inventive pyrolysis product and for the use of a shaped body formed from unpyrolysed carbohydrate or carbohydrate mixture and the amorphous carbon component, especially preferably in the abovementioned weight ratios, as a feedstock in the production of silicon, preferably metallurgical silicon or solar silicon, by reduction of SiO₂ at elevated temperature, especially in a light arc furnace.

When the inventive pyrolysis product is used as a feedstock in the production of silicon, preferably metallurgical silicon or solar silicon, by reduction of SiO₂ at elevated temperature, preference is given to first producing a shaped body with a defined form, for example by granulating, pelletizing, tabletting, extruding—to name just a few examples—with optional addition of further components, such as pure or highly pure SiO₂, activators such as SiC, binders such as organosilanes, organosiloxanes, carbohydrates, silica gel, natural or synthetic resins, and high-purity processing assistants, such as pressing, tabletting or extruding assistants, such as graphite.

A pure carbohydrate or pure amorphous carbon or pure silica or pure pyrolysis product features a content of:
a. aluminium less than or equal to 5 ppm, preferably between 5 ppm and 0.0001 ppt, especially between 3 ppm and 0.0001 ppt, preferably between 0.8 ppm and 0.0001 ppt, more preferably between 0.6 ppm and 0.0001 ppt, even better between 0.1 ppm and 0.0001 ppt, even more preferably between 0.01 ppm and 0.0001 ppt, even more preference being given to 1 ppb to 0.0001 ppt,
b. boron less than 10 ppm to 0.0001 ppt, especially in the range from 5 ppm to 0.0001 ppt, preferably in the range from 3 ppm to 0.0001 ppt or more preferably in the range from 10 ppb to 0.0001 ppt, even more preferably in the range from 1 ppb to 0.0001 ppt,
c. calcium less than or equal to 2 ppm, preferably between 2 ppm and 0.0001 ppt, especially between 0.3 ppm and 0.0001 ppt, preferably between 0.01 ppm and 0.0001 ppt, more preferably between 1 ppb and 0.0001 ppt,
d. iron less than or equal to 20 ppm, preferably between 10 ppm and 0.0001 ppt, especially between 0.6 ppm and 0.0001 ppt, preferably between 0.05 ppm and 0.0001 ppt, more preferably between 0.01 ppm and 0.0001 ppt and most preferably 1 ppb to 0.0001 ppt;
e. nickel less than or equal to 10 ppm, preferably between 5 ppm and 0.0001 ppt, especially between 0.5 ppm and 0.0001 ppt, preferably between 0.1 ppm and 0.0001 ppt, more preferably between 0.01 ppm and 0.0001 ppt and most preferably between 1 ppb and 0.0001 ppt,
f. phosphorus less than 10 ppm to 0.0001 ppt, preferably between 5 ppm and 0.0001 ppt, especially less than 3 ppm to 0.0001 ppt, preferably between 10 ppb and 0.0001 ppt and most preferably between 1 ppb and 0.0001 ppt,
g. titanium less than or equal to 2 ppm, preferably less than or equal to 1 ppm to 0.0001 ppt, especially between 0.6 ppm and 0.0001 ppt, preferably between 0.1 ppm and 0.0001 ppt, more preferably between 0.01 ppm and 0.0001 ppt and most preferably between 1 ppb and 0.0001 ppt,
h. zinc less than or equal to 3 ppm, preferably less than or equal to 1 ppm to 0.0001 ppt, especially between 0.3 ppm and 0.0001 ppt, preferably between 0.1 ppm and 0.0001 ppt, more preferably between 0.01 ppm and 0.0001 ppt and most preferably between 1 ppb and 0.0001 ppt.

A high-purity carbohydrate or amorphous carbon or silica or pyrolysis product is notable in that the sum of the abovementioned impurities is less than 10 ppm, preferably less than 5 ppm, more preferably less than 4 ppm, even more preferably less than 3 ppm, especially preferably 0.5 to 3 ppm and very especially preferably 1 ppm to 3 ppm. For each element, the aim may be a purity in the region of the detection limit.

The definitions of metallurgical and solar silicon are common knowledge. For instance, solar silicon has a silicon content of greater than or equal to 99.999% by weight.

The determination of impurities is performed by means of ICP-MS/OES (inductively coupled spectrometry-mass spectrometry/optical electron spectrometry) and AAS (atomic absorption spectroscopy).

The present invention is explained and illustrated in detail by the examples which follow and the comparative example, without restricting the subject-matter of the invention.

### EXAMPLES

### Comparative Example 1

5 g of a commercial refinery sugar were melted in a test tube having a length of 18 cm and a diameter of 18 mm, and then heated to about 400° C. The reaction mixture foams significantly as it is heated. The sugar caramelizes and carbonizes. The pyrolysis product formed adheres to the wall of the reaction vessel. The foam height in the test tube is 10 cm.

### Examples 2-10

Commercial refinery sugar was mixed together with carbon black in different weight ratios, melted and heated to about 400° C. The sugar caramelizes and carbonizes. Foam formation is significantly reduced or absent. The carbon blacks used differ in terms of surface area, structure and surface chemistry.

The results are summarized in Table 1 below.

It can be seen from Table 1 that especially gas blacks (see FW1), which generally have a very low pH, and furnace blacks with low structure, i.e. low DBP number (see Printex 35 compared to Printex 30 and Printex 3), have particularly good defoamer properties. According to the amount used, however, a good defoamer action can also be achieved with other carbon blacks.

TABLE 1

| | | Comparative | | | | | | | | | |
|---|---|---|---|---|---|---|---|---|---|---|---|
| | | example 1 | Example 2 | Example 3 | Example 4 | Example 5 | Example 6 | Example 7 | Example 8 | Example 9 | Example 10 |
| Amount of | g | 5 | 4.95 | 4.5 | 4.975 | 4.95 | 4.9 | 4.9 | 4.95 | 4.9 | 4.9 |
| sugar | | | | | | | | | | | |
| Amount of | g | 0 | 0.05 | 0.5 | 0.025 | 0.05 | 0.1 | 0.1 | 0.05 | 0.1 | 0.1 |
| carbon black | | | | | | | | | | | |
| Foam height | cm | 10 | 8 | 4 | 7.5 | 3.5 | 3 | 7 | no foam | 3 | no foam |
| | | | | | | | | | formation | | formation |
| Carbon black | | — | Durex | Durex | Colour Black FW171 | | | Printex 30 | FW1²⁾ | Printex 3 | Printex 35 |
| type¹⁾ | | | | | | | | | | | |
| BET | m²/g | — | 20 | 20 | 620 | 620 | 620 | 80 | 320 | 80 | 65 |
| STSA | m²/g | — | 18.5 | 18.5 | 365 | 365 | 365 | 78 | 205 | 75.5 | 62 |
| DBP | ml/100 g | — | 117 | 117 | 110 | 110 | 110 | 105 | n.d. | 123 | 42 |
| pH | | — | 7.5 | 7.5 | 8 | 8 | 8 | 9.5 | 3.5 | 9.5 | 9 |
| Volatile | % | — | 0.5 | 0.5 | 1.5 | 1.5 | 1.5 | 0.7 | 5.0 | 0.9 | 0.5 |
| constituents | | | | | | | | | | | |

¹⁾All carbon blacks used are obtainable from EVONIK ® Degussa GmbH
²⁾FW1 gas black

1. A process for industrial pyrolysis of a carbohydrate or carbohydrate mixture, wherein the process is performed with addition of amorphous carbon.

2. The process according to claim 1, wherein
the amorphous carbon is activated carbon or a carbon black or a pyrolysed carbohydrate, or mixtures thereof.

3. The process according to claim 2, wherein
the amorphous carbon is a carbon black, with a BET surface area of 1 to 1000 m²/g, an STSA surface area of 1 to 600 m²/g, a DBP of 10 to 300 ml/100 g or a pH of less than or equal to 11, or any combination thereof.

4. The process according to claim 1, wherein
the carbohydrate is at least one crystalline sugar.

5. The process according to claim 1, wherein
the carbohydrate and the amorphous carbon are used in a weight ratio of 1000:0.1 to 0.1:1000.

6. The process according to claim 1, wherein
a mixture of carbohydrate and amorphous carbon is subjected before the pyrolysis to a shaping process, and the resulting shaped body is pyrolysed.

7. The process according to claim 1, wherein
the pyrolysis is performed at a temperature of below 800° C.

8. The process according to claim 1, wherein
the pyrolysis is performed at a pressure between 1 mbar and 1 bar, or in an inert gas atmosphere, or a combination thereof.

9. The process according to claim 1, wherein
the carbohydrate components and/or the amorphous carbon component is used in pure or highly pure form, with a content of:
a. aluminium less than or equal to 5 ppm,
b. boron less than 10 ppm to 0.0001 ppt,
c. calcium less than or equal to 2 ppm,
d. iron less than or equal to 20 ppm;
e. nickel less than or equal to 10 ppm,
f. phosphorus less than 10 ppm to 0.0001 ppt,
g. titanium less than or equal to 2 ppm,
h. zinc less than or equal to 3 ppm,
and having a sum of the abovementioned impurities of less than 10 ppm.

10. A composition obtained according to the process of claim 1.

11. A pyrolysis product formed from at least one carbohydrate, wherein the product has a very low ash content of less than 0.5% by weight, or a content of:
a. aluminium less than or equal to 5 ppm,
b. boron less than 10 ppm to 0.0001 ppt,
c. calcium less than or equal to 2 ppm,
d. iron less than or equal to 20 ppm;
e. nickel less than or equal to 10 ppm,
f. phosphorus less than 10 ppm to 0.0001 ppt,
g. titanium less than or equal to 2 ppm,
h. zinc less than or equal to 3 ppm.

12. (canceled)

13. A process for producing silicon, wherein
a mixture of a carbohydrate and an amorphous carbon are pyrolysed at temperatures of 400 to 700° C., and the pyrolysis product is subsequently used to produce silicon.

14. A process for producing silicon, wherein
a mixture of a carbohydrate and an amorphous carbon is introduced in unpyrolysed form into a reduction reactor, a carbon reducing agent is produced in situ therein by pyrolysis and the carbon reducing agent is subsequently reacted with silica or silicon carbide to give silicon.

15. The process according to claim 13, wherein a moulding is first produced from the mixture of carbohydrate and amorphous carbon, and then pyrolysed.

16. A process for producing silicon, wherein a graphite electrode or graphite mouldings according to claim 12 are used as apparatus constituents.

17. The process according to claim 1, wherein
the amorphous carbon is pyrolysed sugar.

18. The process according to claim 3, wherein
the carbon black is a gas black or a furnace black or a lamp black or a mixture thereof.

19. The process according to claim 6, wherein
the shaping process is selected from briquetting, extrusion, pressing, tabletting, pelletizing and granulating.

20. The process according to claim 1, wherein
the pyrolysis is performed at a temperature between 800 and 1700° C.

21. A process for the production of a product, comprising including the pyrolysis product of claim 1 in the process, wherein the product is selected from silicon, graphite mouldings, carbon brushes, heating elements, heat exchangers, steel, diamond, zirconium and a metal selected from W, Mo, Cr, Ti, Ta, Co and V.
